(19) United States
(12) Patent Application Publication
(10) Pub. No.: US 2014/0228082 A1
(43) Pub. Date: Aug. 14, 2014

(54) Organizational System

(71) Applicants: Brad Morrow, Blairstown, NJ (US); Jeffrey Radwin, Columbus, NJ (US)

(72) Inventors: Brad Morrow, Blairstown, NJ (US); Jeffrey Radwin, Columbus, NJ (US)

(21) Appl. No.: 14/175,213

(22) Filed: Feb. 7, 2014

Related U.S. Application Data
(60) Provisional application No. 61/764,842, filed on Feb. 14, 2013.

(51) Int. Cl. H04B 1/38

(52) U.S. Cl. CPC H04B 1/3888
USPC 455/575.8

(57) ABSTRACT

The present disclosure provides for an organizational system using a protective cell phone case, hinged container, and lanyard. The hinged container couples to the protective cell phone case. The hinged container may be interchangeable or there may be a number of interchangeable cartridges that fit within the hinged container. The cartridges may have a specific functionality such as carrying makeup, money, or a Bluetooth speaker. The lanyard doubles as a set of head phones that can be used with the cell phone or alternate electronic device. The lanyard can clip to either the protective cell phone case, hinged container, or any of the cartridges. The overall system allows a wide variety of items to be carried in a convenient and portable singular unit.

### CLAIM OF PRIORITY

This application claims priority to U.S. Application Ser. No. 61/764,842 filed on Feb. 14, 2013 the contents of which are herein incorporated by reference in its entirety.

### FIELD OF THE INVENTION

The field of the invention relates to organizational systems for conveniently storing and transporting a variety of materials whilst using a minimal space, namely using a cell phone case-lanyard combination to reduce the number of items a person must individually possess. In particular, to having a cell phone case with additional external storage and an associated carrying lanyard possessing headphones for use with the associated cell phone or other electronic device.

### BACKGROUND OF THE INVENTION

Space saving techniques are abound in today's market place. The advent of new technology has, in turn, increased the amount of items most individuals are required to keep on their person at all times. Typically such items comprise at least a cell phone, wallet, identification, keys, credit cards, photos, medicines, and the like. Headphones have become much more popular to carry with the advent of the smart phone and the technological capabilities these phones possess. People can watch videos, conduct video calls, explore the internet, listen to music, and so forth. It is preferable for privacy concerns and is general etiquette to not intrude on others with such audio disturbances.

Further, more items would be carried, if convenient, although such items are often too burdensome to be able to justify. However, this can lead to a number of problems such as not having an item when it's needed, or damage to items from overfilling pockets such as scratches on electronic devices. Additionally, head phones can often tangle thereby damaging the head phones or creating a near impossible mess of items and tangles and knots.

### REVIEW OF RELATED TECHNOLOGY

U.S. Pat. No. 8,499,933 describes a compartmentalized protective case housing a portable electronic device and personal care items that are organized and held securely therewithin. The compartmentalized protective case has a major compartment for receiving and housing an electronic device such as a smart phone, cellular phone, music player, or other digital media device. At least one cell compartment constructed within the case receives and houses personal care items removably integrated therein. Personal care items include a plurality of interchangeable replacement cells containing beauty items, cosmetics, hygienic items, oral care products such as floss or breath strips, medications, vitamins, breath fresheners and/or health care products. A second cell compartment is preferably provided as a removable pouch or restraining system for holding identification cards, currency, visa or bank cards, and/or keys.

U.S. Pat. No. 6,910,718 describes a writing pad attachment for a cellular phone or other handheld electronic device, having a housing, an adjustable writing surface, a marking pad and a writing implement. The housing is releasably attached to the back of a cellular phone. The adjustable writing surface is located inside of the housing and is slideably adjusted to a locked position outside of the housing to provide a sturdy writing surface. Alternatively, the adjustable writing surface may be released from the housing and placed in a more convenient location. The adjustable writing surface is either a tray or a flat slate. The housing may be detached from the back of the cellular phone to provide a more convenient writing surface for the user. The writing pad attachment also provides a locking mechanism for securing the adjustable writing surface in a desired position.

U.S. Pat. No. 5,348,347 describes a pocketbook size organizer that can store a portable cellular phone. The organizer comprises a flexible book which has a first cover portion that can fold onto a center cover portion and a second cover portion that folds onto the first cover portion. The book has a hook and loop material that fastens the second cover to the first cover to secure the organizer in a folded condition. The inside of the first cover has a pair of straps that secure the portable phone to the book. The straps are attached together by the hook and loop material which allows the organizer to carry phones having different outer dimensions. The book also contains a pocket which can receive a calculator and a slit that can capture a note pad. The organizer can be carried by a handle which is attached to the book and has a free end that can be coupled to the outer surface of the center cover by the hook and loop material.

Various devices are known in the art. However, their structure and means of operation are substantially different from the present disclosure. The other inventions also fail to solve all the problems taught by the present disclosure. The present invention provides for a number of components, some interchangeable, that can be used seamlessly in conjunction with one another. This drastically saves the amount of space required to carry such objects individually and prevents damage to the objects. At least one embodiment of this invention is presented in the drawings below and will be described in more detail herein.

### SUMMARY OF THE INVENTION

An organizational system is described and taught having a protective cell phone case with at least one rail disposed along an outer surface of the protective cell phone case; a hinged container slideably coupled to the protective cell phone case by way of the at least one rail, wherein the hinged container has a first side having a first outer surface and a first inner surface and a second side having a second outer surface and a second inner surface, the first side and the second side are coupled with a hinge; and a lanyard attached to a lanyard bar having a first end and a second end, wherein the first end has an audio jack and at least one attachment clip and the second end has a pair of headphones, wherein a length of zipper spans the distance between the first end and the second end, the length of zipper having a zipper clip. The protective cell phone case may further have a lanyard bar located on an exterior surface of the case for attachment or the lanyard may attach to the same on the hinged container.

Preferably the organizational system has a protective cell phone case that provides some element of protection to the cell phone within the case. In some instances the protective cell phone case is at least water resistant and may be water proof. The case may also further protect against the elements, such as dirt and grime, and shock stemming from dropping of the phone and case. The protective cell phone case preferably has two

L-shaped rails laterally situated along the rear of the case. The rails engage a similar groove structure on a hinged container. The two structures engage and enable a slideable coupling of the cell phone case and the hinged container. There is a locking mechanism which secures the hinged container to the rails. The rails may further have one and preferably two hinged container releases. By depressing these releases, one can disengage the hinged container from the rails. This enables the hinged container to be used singularly or in conjunction with the protective cell phone case.

The hinged container has a locking system employing male/female locking structures, which secure the first side and the second side of the hinged container. This allows the hinged container to be securely opened or closed and permits for the storage of valuables such as money, jewelry, and the like. The hinged container(s) are interchangeable and can contain any number of cartridges such as a wallet cartridge, smokers cartridge, slim cartridge, Bluetooth® cartridge, memory cartridge, hollow cartridge, makeup cartridge, party cartridge, charging cartridge, medicine cartridge, coupon cartridge, or a drinking game cartridge. Additionally, the cartridges may be readily interchangeable and may further have a lanyard bar for attachment and singular use with the lanyard. In order to use the lanyard, one simply zips the zipper forming a unified, zipped length of material and uses the attachment clip and the zipper clip to form a looped lanyard. Alternatively, the looped lanyard can be unhooked and used as headphones with the audio jack fitting into a standard audio jack receptor present on any number of electronic devices.

In another aspect of the invention there is an organizational cell phone case having a protective cell phone case having at least one removable rail disposed along an outer surface of the protective cell phone case; and a hinged container slideably coupled to the protective cell phone case by way of the at least one rail, wherein the hinged container has a first side having a first outer surface and a first inner surface and a second side having a second outer surface and a second inner surface, the first side and the second side coupled with a hinge, wherein the first inner surface and the second inner surface have an cartridge. Further, the protective cell phone case may have a lanyard. The lanyard is preferably attached to the lanyard bar of the protective cell phone case having a first end and a second end, wherein the first end has an audio jack and at least one attachment clip and the second end has a pair of headphones, wherein a length of zipper spans the distance between the first end and the second end, the length of zipper having a zipper clip.

Further, there may be another embodiment of the organizational system having a hinged container having an lanyard bar disposed on an outer surface of the hinged container, wherein the hinged container has a first side having a first outer surface and a first inner surface and a second side having a second outer surface and a second inner surface, the first side and the second side coupled with a hinge; and a lanyard attached to the lanyard bar of the hinged container, the lanyard having a first end and a second end, wherein the first end has an audio jack and at least one attachment clip and the second end has a pair of headphones, wherein a length of zipper spans approximately the distance between the first end and the second end, the length of zipper having a zipper clip.

In general, the present invention succeeds in conferring the following, and others not mentioned, benefits and objectives.

It is an object of the present invention to provide an organizational system that has interchangeable components.

It is an object of the present invention to provide an organizational system that is lightweight and readily transportable.

It is an object of the present invention to provide an organizational system with features having at least dual functionality.

It is an object of the present invention to provide an organizational system that stores components in a singular unit making items easy to find.

It is an object of the present invention to provide an organizational system that is weather resistant.

It is another object of the present invention to provide an organizational system that provides for the transporting and/or storage of specific items.

It is another object of the present invention to provide an organizational system that prevents damage from occurring to commonly carried and various other items.

It is another object of the present invention to provide an organizational system that may be used as an identification device.

It is yet another object of the present invention to provide an organizational system that has components which can be used solely or in conjunction with one another.

It is yet another object of the present invention to provide an organizational system that provides a secure method of storing valuables.

### BRIEF DESCRIPTION OF THE DRAWINGS

FIG. 1 is a back view of a protective cell phone case without the hinged container attached thereto.

FIG. 2A is a bottom view of the protective cell phone case without the hinged container attached thereto.

FIG. 2B is a bottom view of the protective cell phone case with the hinged container attached thereto.

FIG. 3 is a back view of a protective cell phone case with the hinged container attached thereto.

FIG. 4 is a side view of a protective cell phone case with the hinged container attached thereto.

FIG. 5 is a top view of a protective cell phone case with the hinged container attached thereto.

FIG. 6A is a front view of one embodiment of the hinged container in the closed position.

FIG. 6B is a front view of the hinged container in the open position showing one of the potential cartridges.

FIG. 7A is a front view of the lanyard of the present invention.

FIG. 7B is a close up view of the attachment clip(s) and audio jack of the lanyard.

FIG. 8 is a perspective view of a preferred embodiment of the organizational system of the present invention combined as intended.

### DETAILED DESCRIPTION OF THE DRAWINGS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

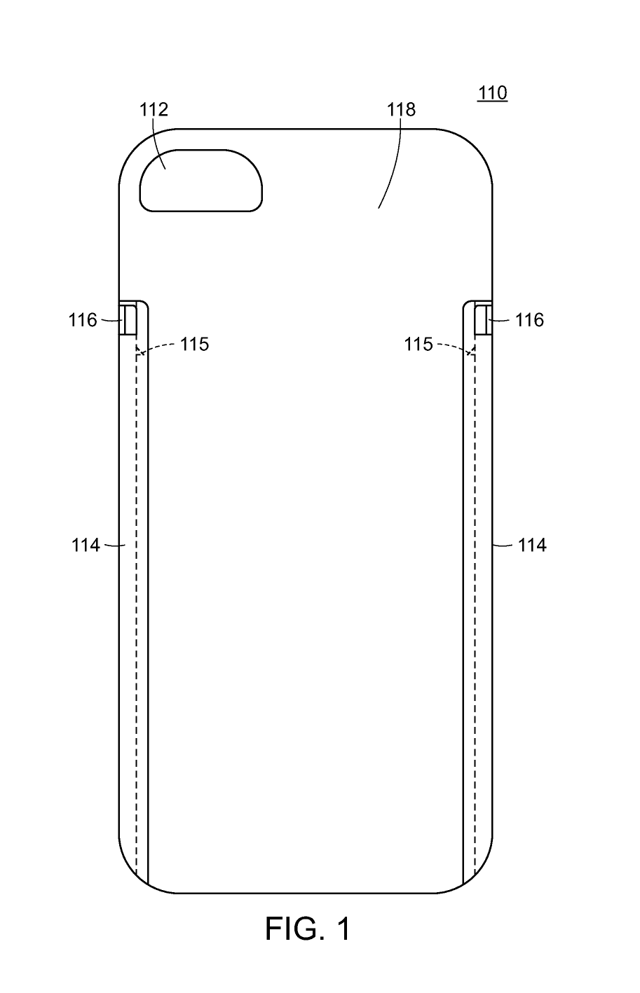

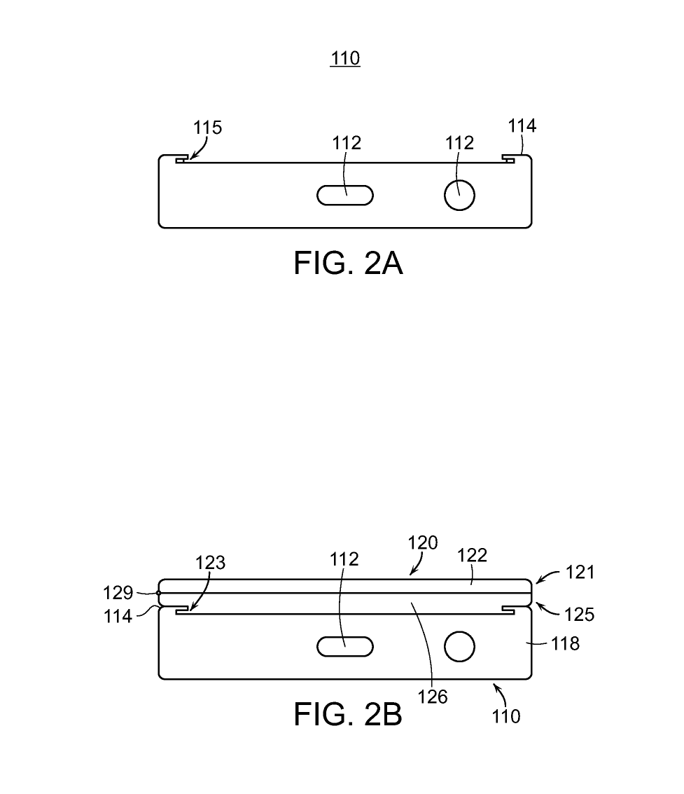

Referring to FIG. 1, there is one component of the organizational system 100 of the present invention. The protective cell phone case 110 is shown from the rear in order to best demonstrate the features of the protective cell phone case 110. Along at least one, and preferably two, lateral edges of the protective cell phone case 110 are rail(s) 114. These rails 114 have an L-shape and a locking mechanism 115 (see FIG. 2). The rails 114 may be disposed vertically or horizontally across the outer surface 118 of the protective cell phone case 110, as long as the rails 114 do not interfere with the functionality of the phone and case 110. At one end of the rails 114, there is a hinged container release 116. Each one of the rails 114 preferably has its own hinged container release 116. Additionally, the protective cell phone case 110 may have a lanyard bar 105 (not shown) disposed along an outer surface 118.

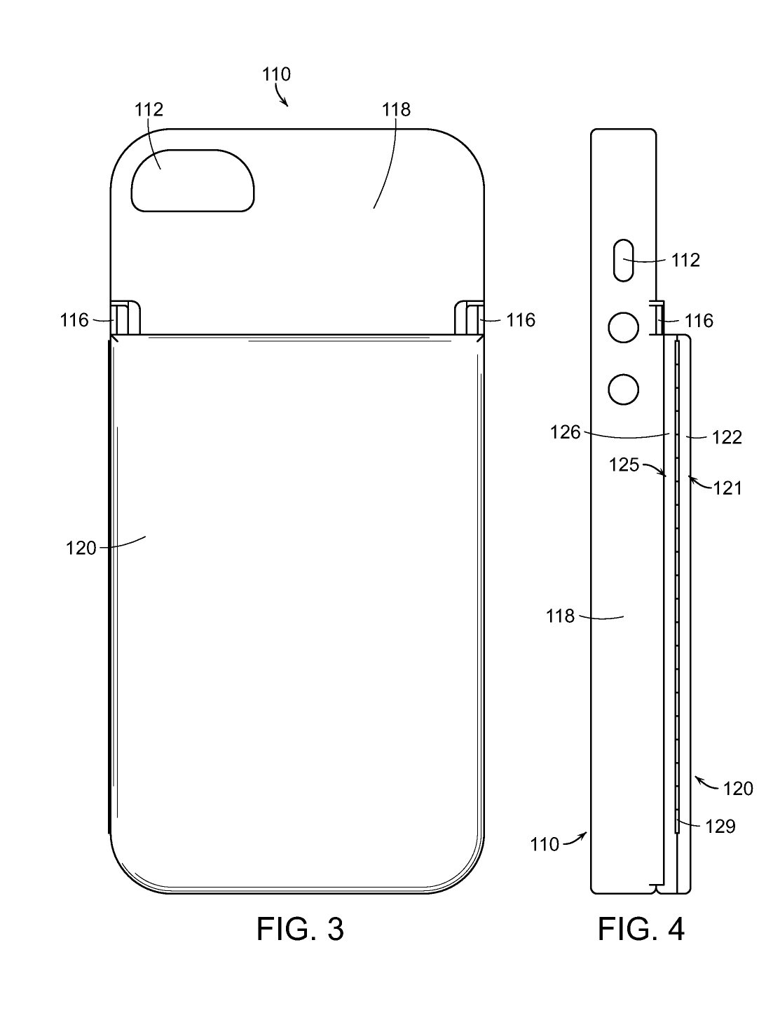

FIG. 2A shows a bottom view of the protective cell phone case 110. Here, the L-shape (inverted) of the rails 114 is readily apparent. In some instances, the rails 114 may have a different shape or size depending on their intended function. The locking mechanism 115 engages a particular point, such as a notch, of the hinged container 120 (see FIG. 3). The locking mechanism 115 secures the hinged container 120 (see FIG. 2B) at a position along the rails 114. In FIG. 2B, the hinged container 120 is positioned and locked on the rails 114 and has a first side 121 and a second side 125. The two sides are connected with a hinge 129. The first side 121 has a first outer surface 122 and the second side 125 has a second outer surface 126. Here, the relationship between the grooves 123 of the hinged container 120 and the rails 114 on the protective cell phone case 110 are clearly evident.

In FIG. 3, there is a back view of the protective cell phone case 110 where the hinged container 120 has been positioned and secured along the rails 114 by the locking mechanism 115. The hinged container 120 has a groove similar, but opposite, in shape to the rails 114. This allows the hinged container 120 to be slideably engaged to the rails 114. The locking mechanism 115 then secures the position of the hinged container 120, thereby preventing the hinged container 120 from becoming lost or becoming disengaged, falling, and breaking it or the contents therein. In order to remove the hinged container 120, one simply depresses either one or both of the hinged container releases 116. This disengages the locking mechanism 115 and enables the slideable movement of the hinged container 120. Further, the hinged container 120 does not cover integral parts of the cell phone, such as the camera and/or flash. The protective cell phone case 110 provides for openings 112 that allow the cell phone to maintain functionality. In some cases, these openings 112 may be uncovered, partially covered, or fully covered such as with the camera lens or exterior cell phone buttons. The openings 112 in the case provide an avenue by which buttons can still be depressed or enable pictures to be taken.

FIG. 4 shows a side view of the protective cell phone case 110 with the hinged container 120. From the side, more openings 112 in the protective cell phone case 110 are visible. As previously described, the openings may be partially or fully covered while still providing functionality to the differing components. The rail 114 and hinged container release 116 are shown. The hinged container 120 may fully reside within the lengths of the rails 114 or the hinged container 120 may be larger than the rails 114. Additionally, the hinge 129 between the first side 121 and the second side 125 is visible. The hinge 129 may be placed on the opposite lateral edge or any of the lateral edges comprising the hinged container 120.

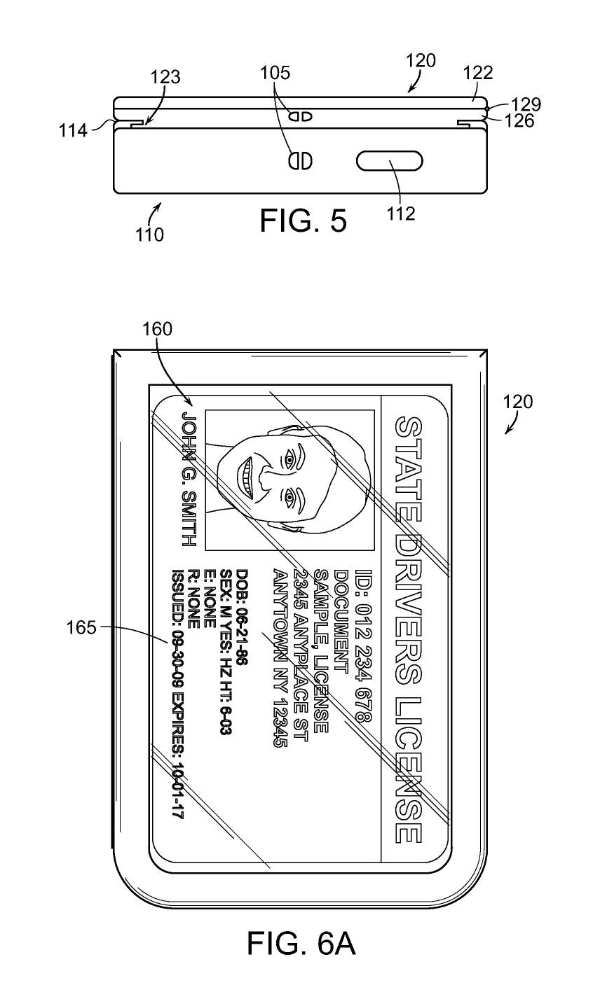

FIG. 5 shifts the view from the side of the protective cell phone case 110 with the hinged container 120 to the top. The interaction between the grooves 123 in the hinged container 120 and the rails 114 is readily apparent. The shape of the rails 114 is complimentary to the grooves 123. The hinged container release can sit on either an outside edge or top edge of the rails 114. Further, the lanyard bar 105 is visible on top of the hinged container 120 and the protective cell phone case 110. The lanyard bar 105 is generally a shallow indentation in the outer structure of the hinged container 120 (or protective cell phone case or interchangeable cartridge) with a small bar traversing the width of the indentation. Thus, a clip can be attached directly to the lanyard bar 105 or a length of a lanyard can be threaded under the lanyard bar 105 and attached in the fashion.

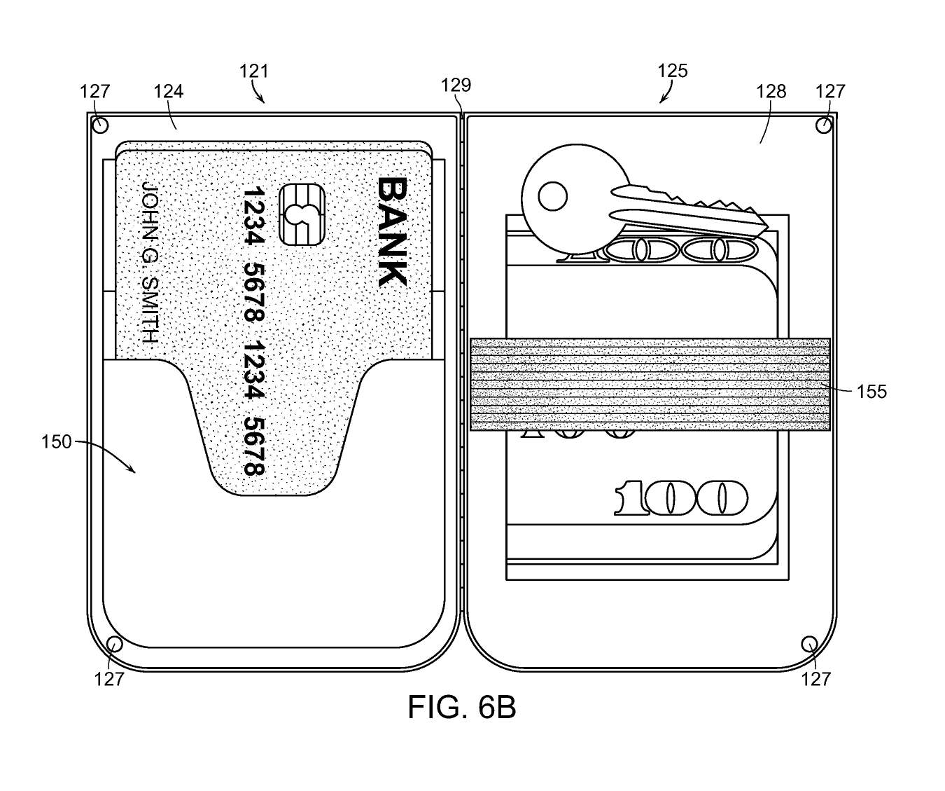

FIGS. 6A and 6B show the hinged container 120 in a closed and open position respectively. The hinged container 120 comprises a first side 121 and a second side 125. The first side 121 has a first outer surface 122 and a first inner surface 124. The second side 125 has a second outer surface 126 and a second inner surface 128 (see FIG. 6B). In the closed position, the hinged container 120 can have a number of outward appearance variations on the outer surfaces 122, 126 such as color, material, texture, and the like. There may be images, logos, or slogans as well that correspond to the contents of the hinged. In some instances, panels bearing such slogans, logos, images, colors, materials, textures, and so forth may be interchangeable. In at least one embodiment, the hinged container 120 may have substantially transparent section 160 which can be used to display an identification 165 such as a driver's license, passport, concert ticket, or the like.

Internally, the hinged container's 120 contents are shown in FIG. 6B. Shown is one of the possible cartridges available, a slim cartridge. This cartridge has pockets 150 for storing credit cards, identification cards, and the like. The alternate side has a clip or band 155 that can hold cash or any other desirable object. This is just one of the possible options amongst the virtually limitless options. The two sides of the hinged container 120 are held together by a hinge 129. The hinge 129 allows the two sides to open and should enable the sides to rest substantially flat. It may be desirable to employ a hinge 129 that prevents the sides from opening, or rotating, past parallel with respect to one another. Further, the hinged container 120 has male/female locking members 127. These secure the hinged container 120 preventing it from randomly opening and causing an individual to lose or damage the contents of the hinged container 120. In some embodiments, the hinged container 120 may have a water resistant or water proof seal that protects the internal cartridge from the elements.

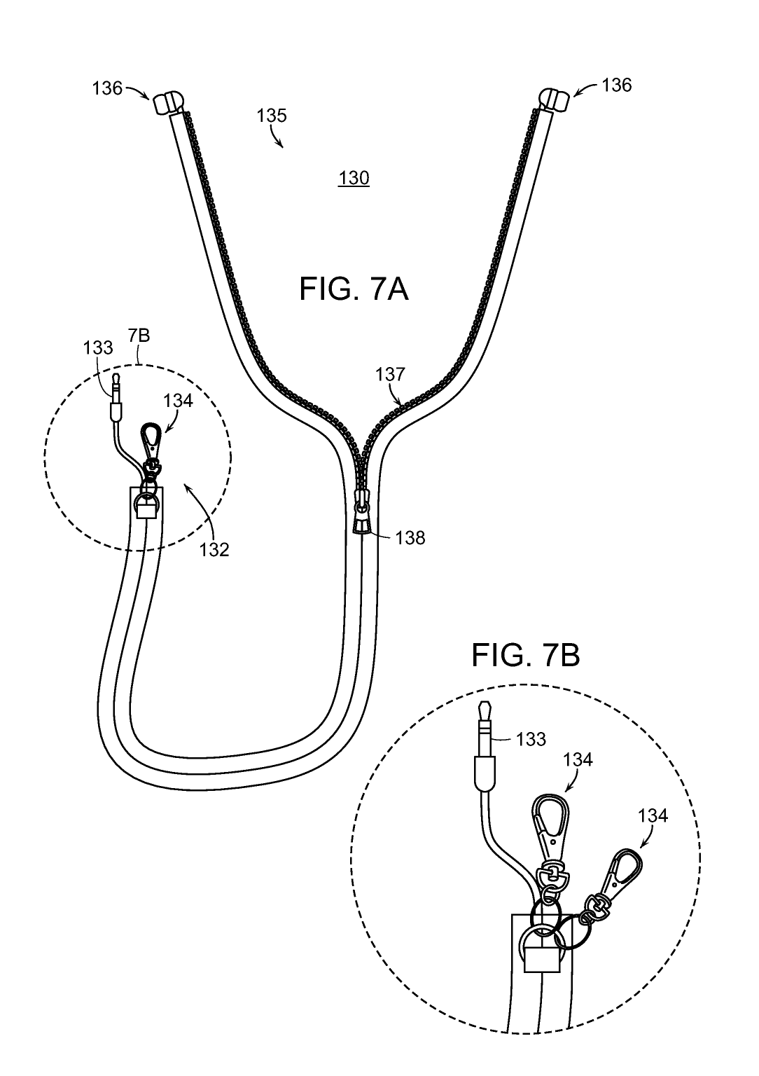

FIGS. 7A and 7B illustrate the lanyard 130 and the various configurations in which it may be employed. The lanyard 130 generally has a first end 132 and a second end 135. The first end has an audio jack 133 and at least one attachment clip 134. The audio jack 133 may be used in conjunction with any standard audio jack receptor present on electronic devices. The second end 135 has a pair of headphones 136. In between the first end 132 and the second end 135 is a length of zipper 137. The length of zipper 137 runs approximately the distance from the first end 132 to the second end 135. The zipper 137 is zipped or unzipped by a zipper clip 138. The zipper clip 138 can also attach to at least one of the attachment clips 134 forming a looped lanyard 140 (see FIG. 7B). The pair of headphones 136 and the audio jack 133 may be retractable or non-retractable. The pair of headphones 136 may also further employ magnets, male/female connectors, or other acceptable coupling mechanisms. The looped lanyard 140 can be worn around the neck, wrist, arm, or the like of the individual. The lanyard 130 may be adjustable in length to accommodate individuals of differing sizes.

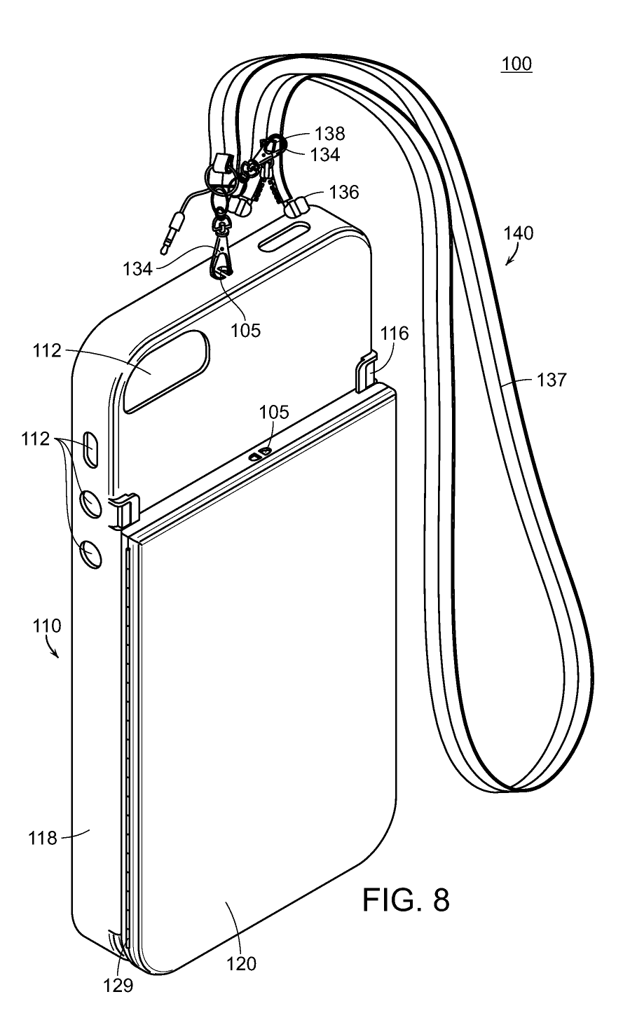

FIG. 8 show the components of the present invention combined as intended for the efficient storage and transportation of a variety of objects. Here, the looped lanyard 140 is attached to the lanyard bar 105 of the protective cell phone case 110. The hinged container 120 is coupled to the protective cell phone case 110 by way of a pair of rails 114. The hinged container 120 is secured into position by a locking mechanism 115. The organizational system 100 can then be carried by the looped lanyard 140 or placed around a body part such as the arm or neck. Further, the organizational system 100 may be broken down into sub parts such as the hinged container 120 and the lanyard 130, the lanyard 130 protective cell phone case 110, and the hinged container 120 and the protective cell phone case 110.

In general the organizational system 100 shown in FIGS. 1-8 can comprise all three individual components (lanyard 130, hinged container 120, and protective cell phone case 110) or use a combination of at least two of the components as described above. The protective cell phone case 110 should comprise in part or wholly glass, plastics, rubbers, textiles, metals, composites, and the like or any combination thereof. Appropriate textiles may include but are not limited to, cotton, silk, viscose, modal, wool, soy fabric, or bamboo or any combination thereof. Plastics may include but are not limited to polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or any combination thereof. Some or all of the protective cell phone case 110 may be metal including but not limited to iron, stainless steel, tin, aluminum, copper or various alloys. Rubbers may include but are not limited to natural rubber, SBR, Isoprene rubber, Butadiene rubber, and (poly)chloroprene rubber. Additionally, suitable composites may comprise a number of different materials including fiber reinforced composites such as fiberglass, carbon fiber containing polymers, and the like. The hinged container and lanyard may comprise any of the aforementioned materials and may further include leathers.

The protective cell phone case 110 should completely envelop the cell phone thereby protecting the phone from the elements such as cold, heat, dirt, dust, and the like. Preferably, the protective cell phone case is at least water resistant and may be water proof. The various openings 112 in the protective cell phone case 110 may be covered with a softer or more pliable material than the remainder in the case. This enables the underlying buttons, sliders, switches, and the like to be manipulated while the phone is in the case. In some instances, the protective cell phone case 110 leaves the visual display or other parts of the phone uncovered. While the discussion of the cell phone case 110 has centered on the cell phone it should be readily apparent that the same principles can be applied to any number of electronic device such as MP3 devices, portable gaming systems, tablets, PDAs, and the like.

The hinged container 120 may comprise a number of differing cartridges. Preferably, the cartridges are unique to the hinged container 120 to which they are held; however, in some instances, the cartridges may be interchangeable. The cartridges may include a wallet cartridge designed to hold money, a smoker's cartridge which holds a plurality of cigarettes, a slim cartridge which holds credits cards and/or identification cards, Bluetooth® cartridge which houses a Bluetooth® or other wireless protocol speaker, memory cartridge which is an externally attached hard drive enabling users to store computer or cell phone information and have it readily transferable, hollow cartridge which holds any item that will fit inside, makeup insert which has a mirror on one side and makeup on the other side, party cartridge which holds a number of items including bottle openers/lighters/condoms/etc., charging cartridge which is a device holding a charge with a USB or other adapter which can charge one's phone on the go, medicine cartridge which holds daily/weekly medication in separate, compartmentalized containers, coupon cartridge which is a book of coupons to be used at retail/food/etc. stores, and a drinking game cartridge which has a miniature board for playing drinking games. The hinged container 120 is not limited to the above referenced cartridges and virtually any imaginable cartridge may be employed.

The lanyard 130 should be approximately 76 cm (30 inch) to about 152 cm (60 inch) and preferably be about 89 cm (35 inch) to about 96 cm (38 inch) in length. The lanyard 130 may comprise any combination of the materials recited above and may be comprised of materials giving it expandable properties. In addition to size differentials, the audio jack 133 and headphones 136 may also be retractable or non-retractable in order to provide added comfort to the wearer. As such, either the audio jack 133 or headphones 136 may be retractable or only one of the aforementioned components may be retractable. The zipper 137 may extend the entire length of the lanyard 130 or may comprise a smaller portion of the lanyard 130. The headphones 136 may have their own mechanism of securement such as snaps, male/female connectors, adhesives, magnets, and the like. In some cases, the user can connect the attachment clip 134 to the zipper clip 138 to form a looped lanyard 140. The user can then use a second attachment clip 134 for attachment to a lanyard bard 105 present on any one of the protective cell phone case 110, hinged container 120, or cartridge (if removable).

What is claimed is:

1. An organizational system comprising:
a protective cell phone case having at least one rail disposed along an outer surface of the protective cell phone case;
a hinged container slideably coupled to the protective cell phone case by way of the at least one rail,
wherein the hinged container has a first side having a first outer surface and a first inner surface and a second side having a second outer surface and a second inner surface, the first side and the second side coupled with a hinge,
a lanyard attached to a lanyard bar of the hinged container having a first end and a second end,
wherein the first end has an audio jack and at least one attachment clip and the second end has a pair of headphones,
wherein a length of zipper spans the approximate distance between the first end and the second end, the length of zipper having a zipper clip.

2. The organizational system of claim 1 wherein the attachment clip couples to the zipper clip forming a looped lanyard.

3. The organizational system of claim 1 wherein the audio jack fits into a standard audio jack receptor.

4. The organizational system of claim 1 wherein there are two rails disposed along an outer surface of the protective cell phone case.

5. The organizational system of claim 1 further comprising at least one hinged container release,
wherein the hinged container release disengages a locking mechanism thereby releasing the hinged container from the rail, enabling the hinged container to be slideably removed.

6. The organizational system of claim 5 wherein there are 2 hinged container releases.

7. The organizational system of claim 1 further comprising male and female locking members,
wherein the male and female locking member secure the first side and the second side of the hinged container.

8. The organizational system of claim 1 further comprising a lanyard bar disposed along an outer surface of the protective cell phone case.

9. The organizational system of claim 1 further comprising a lanyard bar on the hinged container.

10. The organizational system of claim 1 wherein the headphones and the audio jack are either retractable or non-retractable.

11. An organizational cell phone case comprising:
a protective cell phone case having at least one removable rail disposed along an outer surface of the protective cell phone case; and
a hinged container slideably coupled to the protective cell phone case by way of the at least one rail,
wherein the hinged container has a first side having a first outer surface and a first inner surface and a second side having a second outer surface and a second inner surface, the first side and the second side coupled with a hinge.

12. The organizational cell phone case of claim 11 wherein the protective cell phone case covers or exposes the cell phone display.

13. The organizational cell phone case of claim 11 wherein the hinged container is a series of interchangeable cartridges.

14. The organizational cell phone case of claim 13 wherein the hinged container contains a wallet cartridge, smokers cartridge, slim cartridge, Bluetooth cartridge, memory cartridge, hollow cartridge, makeup cartridge, party cartridge, charging cartridge, medicine cartridge, coupon cartridge, or drinking game cartridge.

15. The organizational cell phone case of claim 12 wherein the at least one removable rails fits into a groove on the outer surface of the protective cell phone case.

16. The organizational cell phone case of claim 12 further comprising a lanyard bar located on the outer surface of the protective cell phone case.

17. The organizational cell phone case of claim 11 wherein the protective cell phone case is water proof, water resistant, or shock proof, or any combination thereof.

18. The organizational cell phone case of claim 16 further comprising a lanyard attached to the lanyard bar of the protective cell phone case having a first end and a second end,
wherein the first end has an audio jack and at least one attachment clip and the second end has a pair of headphones,
wherein a length of zipper spans the approximate distance between the first end and the second end, the length of zipper having a zipper clip.

19. The organizational cell phone case of claim 18 wherein the attachment clip and the zipper clip couple to one another forming a looped lanyard.

20. An organizational system comprising:
a hinged container having an lanyard bar disposed on an outer surface of the hinged container,
wherein the hinged container has a first side having a first outer surface and a first inner surface and a second side having a second outer surface and a second inner surface, the first side and the second side coupled with a hinge; and
a lanyard attached to the lanyard bar of the hinged container, the lanyard having a first end and a second end,
wherein the first end has an audio jack and at least one attachment clip and the second end has a pair of headphones,
wherein a length of zipper spans approximately the distance between the first end and the second end, the length of zipper having a zipper clip.
